(19) United States
(12) Patent Application Publication
(10) Pub. No.: US 2005/0188622 A1
(43) Pub. Date: Sep. 1, 2005

(54) Vehicular window assembly

(76) Inventor: David E. Nestell, Spring Lake, MI (US)

Correspondence Address: Van Dyke, Gardner, Linn & Burkhart LLP, Suite 207, 2851 Charlevoix Drive, S.E., Grand Rapids, MI, 49546, US

(21) Appl. No.: 11/064,905

(22) Filed: Feb. 24, 2005

Related U.S. Application Data
(60) Provisional application No. 60/547,940, filed on Feb. 26, 2004.

(51) Int. Cl. E06B 7/16

(52) U.S. Cl. 49/441

(57) ABSTRACT

A vehicular window assembly includes a frame member, which is adapted for mounting in a vehicle, a fixed windowpane, and a seal member. The frame member includes an elongate channel formed therein for receiving a moving windowpane therein and a mounting surface. The fixed windowpane has a perimeter edge, an inner surface, and an outer surface, with the perimeter edge spaced from the frame member to thereby define a space. The seal member is mounted to at least the perimeter edge of the fixed windowpane and substantially closes the space between the frame member and the fixed windowpane. The inner surface of the fixed windowpane is secured to the mounting surface of the frame member by a bead of adhesive wherein the frame member and the fixed windowpane comprise a window assembly module.

The present application claims the benefit of provisional application entitled VEHICULAR WINDOW ASSEMBLY, filed Feb. 26, 2004, Ser. No. 60/547,940, which is herein incorporated by reference in its entirety.

### TECHNICAL FIELD AND BACKGROUND OF THE INVENTION

The present invention relates to a window assembly and, more particularly, to fixed and movable window assemblies for vehicles.

Many vehicle door windows include a fixed, generally triangular shaped windowpane and a generally larger movable windowpane. The triangular fixed windowpane increases the viewing area of the window while allowing the movable windowpane to retain a generally rectangular shape. By retaining a rectangular shape, the movable pane can be laterally supported at both its edge over its full range of motion, which provides greater stability to the movable pane. Because the movable windowpane slides upwardly and downwardly adjacent to the fixed windowpane, the molding or trim surrounding the fixed windowpane must include a track or channel along its rearward edge to receive the edges of the movable windowpane. Historically, these interfaces between the windowpanes and the mounting frame have resulted in air and/or water leakage due to gaps or the like.

Recently, window modules have been proposed that secure the channel or track (division bar) to a fixed pane by an injection molded PVC member. In this manner, the fixed pane and the track are formed as a module that is easily transportable and further simpler to install. Moreover, this allows for pre-assembly of at least a portion of the window assembly. However, the molding process is expensive and, further, is not generally flexible. For each different shape of window, the molding apparatus requires a different set of mold plates.

Consequently, there is a need for a method of at least partially assembling a window assembly that will simplify the window installation process and that will be flexible to accommodate different shaped windows without extensive retooling. Furthermore, the window assembly should require a minimal number of separate parts and processes in order to properly install the assembly to the vehicle door.

### SUMMARY

Accordingly, the present invention provides a window assembly that is simple to assemble and, further, is assembled in a manner that has greater flexibility than current processes.

In one form of the present invention, a window assembly includes a frame member, which is adapted for mounting in a vehicle, and at least one fixed pane. The frame member includes an elongate channel, for receiving a movable pane therein, and a mounting flange. The fixed pane includes a seal at its perimeter edge that closes the space between the perimeter of the fixed pane and the frame member. The fixed pane is also mounted to the mounting flange at its inner surface by a bead of adhesive, which is spaced inwardly from the seal, to thereby form a window assembly module.

In another aspect, the window assembly further includes a movable pane, which extends into the elongate channel of the frame member. In a further aspect, the movable windowpane includes a first perimeter edge, which is slidably engagable with the frame member, and a second perimeter edge, which is slidably engagable with another frame member. The outer surfaces of the fixed pane and of the movable windowpane are generally coplanar to form a generally flush appearance when the movable pane is at least partially closed. Preferably, a resilient seal is included in the elongate channel to reduce air and/or water leakage between the movable windowpane and the frame member. The resilient seal may be integrally molded with the frame member and may vary in cross section along the frame member.

In one aspect, the window assembly further includes a bracket for mounting an exterior mirror assembly. The bracket similarly includes a mounting flange to which the fixed pane is secured by a bead of adhesive. In a further aspect, the bracket extends below the fixed pane and, further, is mounted to the frame member on one end.

Preferably, the frame member includes a generally C-shaped channel, which forms the elongated channel for receiving the movable pane. The mounting flange extends from C-shaped channel and, further, includes a mounting surface for mounting the fixed pane, which is inward of the flange of the C-shaped channel so that the fixed pane is substantially aligned with the movable pane.

Therefore, the present invention provides a vehicular window assembly that includes at least one fixed pane and a frame member to which the fixed member is mounted by an adhesive to thereby form a window assembly module that can be quickly and remotely assembled.

These and other objects, advantages, purposes and features of this invention will become apparent upon review of the following specification in conjunction with the drawings.

### BRIEF DESCRIPTION OF THE DRAWINGS

FIG. 1 is a fragmentary perspective view of a window assembly of the present invention;

FIG. 2 is an enlarged view of a fixed window module of the window assembly of FIG. 1;

FIG. 3 is an elevation view of the fixed window module of FIG. 2, as viewed from an interior side of the window assembly;

FIG. 4 is an enlarged view of the fixed window module of FIG. 2 illustrating the mounting bracket for an exterior rearview mirror assembly;

FIG. 5 is a sectional view taken along line V-V of FIG. 4;

FIG. 6 is a sectional view along the line VI-VI in FIG. 4;

FIG. 7 is a perspective view of another window assembly of the present invention;

FIG. 8 is an enlarged view of the window assembly hinge of FIG. 7;

FIG. 9 is a side view of the hinge of FIG. 8;

FIG. 10 is a rear elevation view of the hinge in FIG. 8 illustrating the hinge frame;

FIG. 11 is a section view along the line XI-XI in FIG. 9;

FIG. 12 is a section view along line XII-XII of FIG. 9;

FIG. 13 is a section view along the line XIII-XIII of FIG. 9;

FIG. 14 is a section view along the line XIV-XIV of FIG. 9; and

FIG. 15 is a section view along the line XV-XV of FIG. 9.

### DETAILED DESCRIPTION OF THE PREFERRED EMBODIMENTS

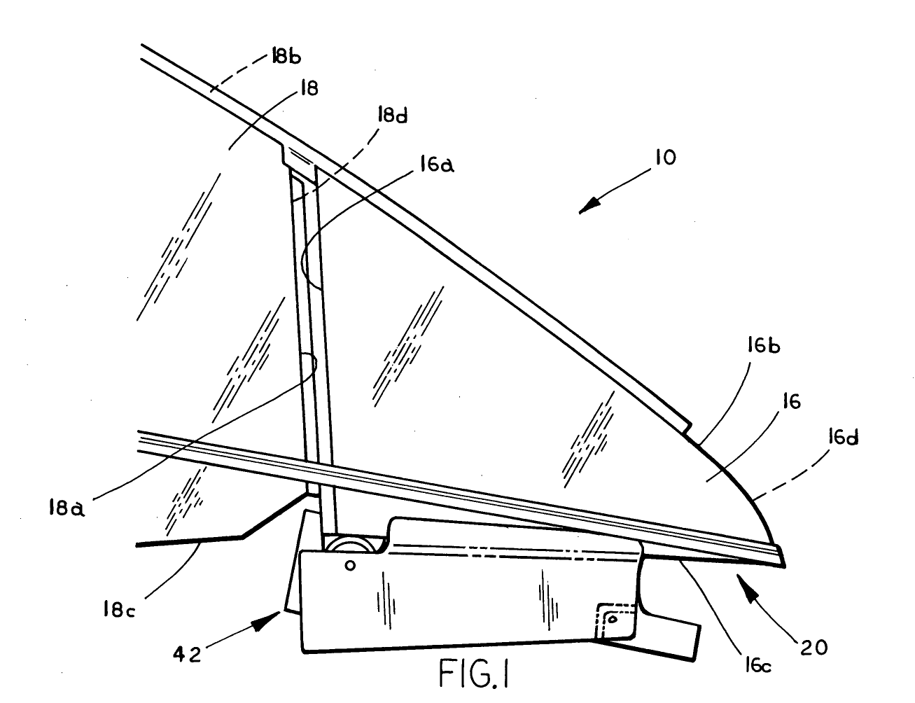

Referring to FIG. 1, the numeral 10 generally designates a window assembly of the present invention. In the illustrated embodiment, window assembly 10 comprises a door window assembly for a front passenger side of a vehicle; however, it can be appreciated that the present invention is similarly applicable to other types of window assemblies, including a rear door. Window assembly 10 is preferably a modular assembly that may be installed in a door or panel of a vehicle. As would be understood from FIG. 1, window assembly 10 includes a fixed vent windowpane 16 and a larger generally rectangular and movable windowpane 18. Movable windowpane 18 may be lowered into the vehicle door to provide an opening through the window assembly, as is known in the art. Preferably, fixed windowpane 16 and movable windowpane 18 are made of a clear or tinted glass. However, either pane 16 or 18 may be molded or formed from a plastic material, such as a polycarbonate material or the like, without affecting the scope of the present invention. The term “pane” is used herein as shorthand for “windowpane”; therefore, these two terms in the present application are used interchangeably.

As will be more fully described below, window assembly 10 includes a window assembly module 20 that facilitates assembly and installation of the window assembly and, further, facilitates remote assembly of the window assembly from the vehicle assembly plant.

Fixed windowpane 16 is shown generally in the shape of a triangle and includes a rearward edge 16a, an upper edge 16b, and a lower edge 16c. However, fixed windowpane 16 may be substantially rectangular in shape or may be another shape depending on the application, without affecting the scope of the present invention. A ceramic frit layer or other known coating is preferably applied to an inner surface 16d of fixed pane 16 along the outer perimeter edges thereof. The frit layer is opaque and functions to facilitate adhering or bonding to the pane, while also improving the overall appearance of the window, since the bonding surfaces, which are typically aligned with the frit layer, are then not visible from the exterior of the vehicle when the window is mounted in the vehicle.

Movable windowpane 18 is generally rectangular-shaped and preferably of a size greater than fixed windowpane 16. Movable windowpane 18 includes a forward edge 18a, an upper edge 18b, a rearward edge (not shown), and a lower edge 18c. Movable windowpane 18 is raised upwardly to a closed position or lowered downwardly to an open position in a conventional manner. Forward edge 18a is adjacent and substantially parallel to rearward edge 16a of fixed pane 16 when movable pane 18 is moved to its closed position.

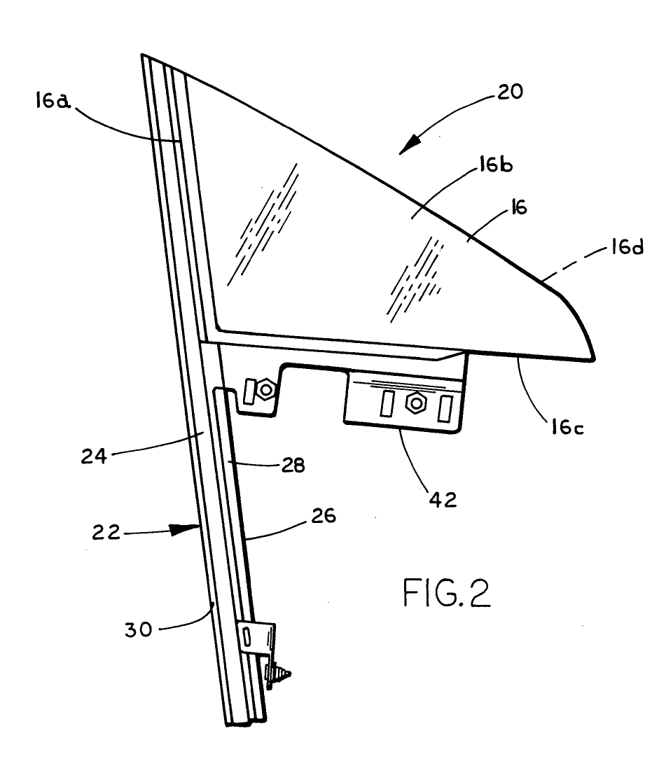

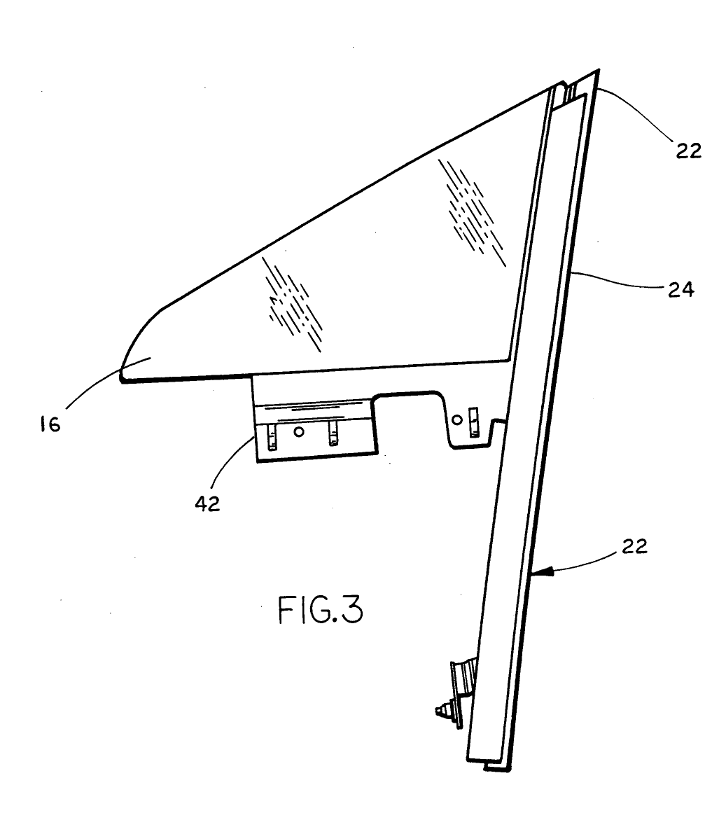

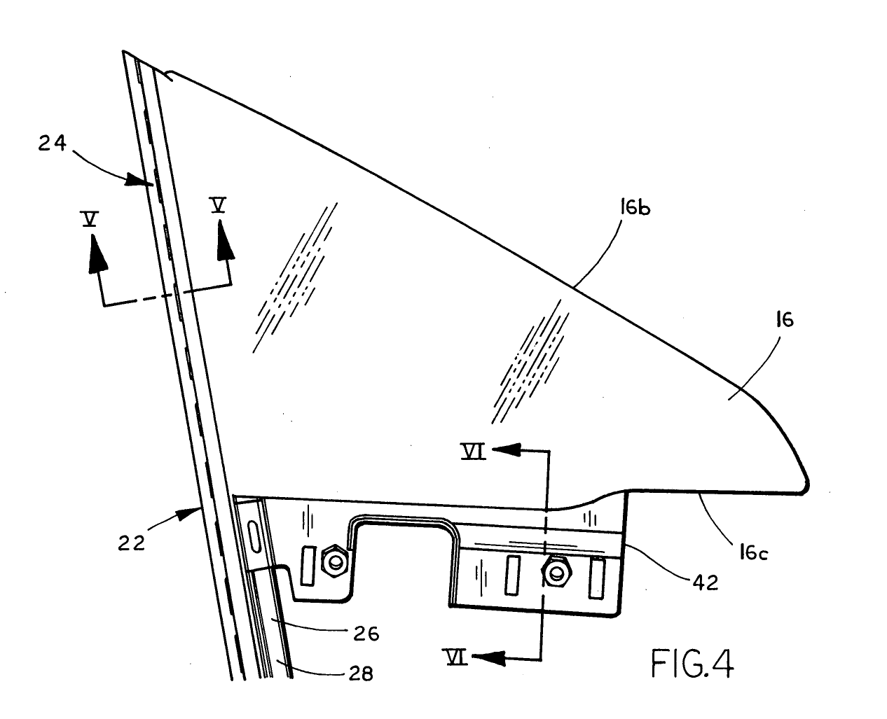

As best seen in FIGS. 2-3, window assembly module 20 includes a frame or frame member 22 to which fixed window pane 16 is mounted. Frame member 22 preferably comprises a metal frame member with a generally C-shaped portion 24, which forms a channel, and a flange portion 26, which projects from C-shaped portion 24 to provide a mounting surface 28 for fixed pane 16. It should be understood that while reference is made herein to a frame member, the frame member may be assembled from more than one component.

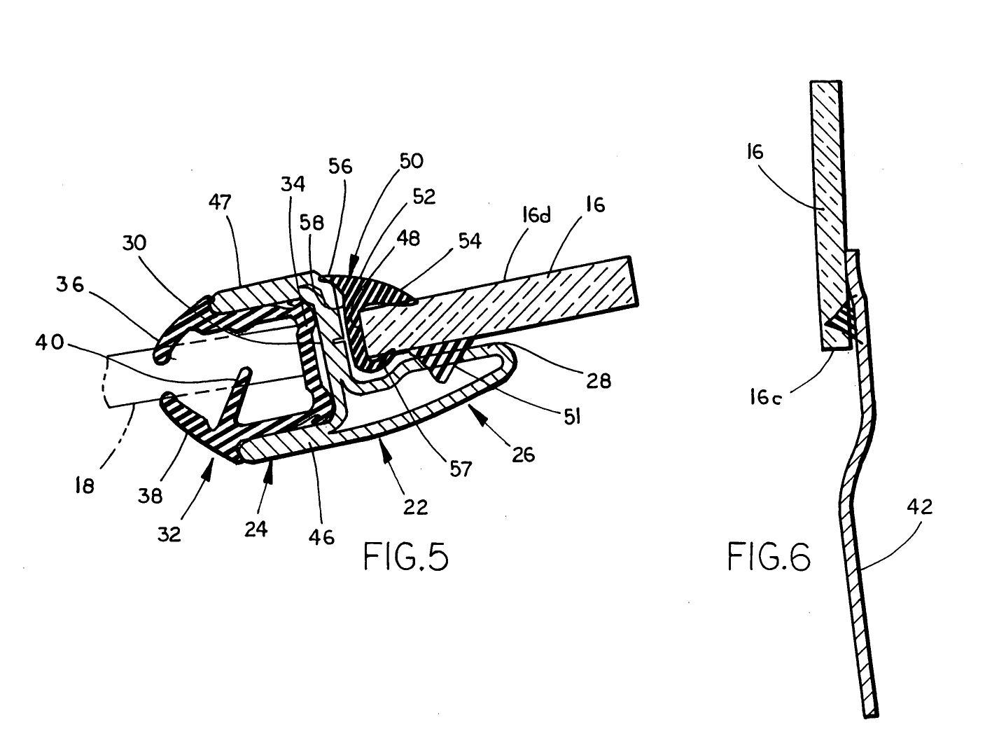

As best seen in FIG. 1, movable windowpane 18 includes opposed substantially parallel free edges, with its forward edge 18a extending into and guided in the elongate channel or track 30 formed by C-shaped portion 24. To seal the interface between movable windowpane 18 and frame member 22, a seal 32 is provided in channel 30 (FIG. 5), which has a generally U-shaped cross-section. Seal 32 includes a U-shaped base 34 that is seated in channel 30 and projecting lips 36 and 38 that project outwardly from C-shaped portion 24 and inwardly toward windowpane 18 for sealingly engaging opposing sides of movable windowpane 18. In addition, seal 32 includes an inwardly projecting lip 40 inward of lip 38 that forms a V-shape seal with lip 38 and also sealingly engages the outer surface of window pane 18 to further reduce air leakage or moisture leakage through the window pane/frame member interface.

As noted above, fixed windowpane 16 is mounted and, preferably, bonded to frame member 22 and also bonded to a bracket 42, which provides a mounting surface for mounting an exterior rearview mirror assembly to window assembly 10. As best shown in FIG. 5, C-shaped portion 24 includes an outer flange 46 and an inner flange 47, which is spaced from outer flange and defines therebetween channel 30. Flange 26 of frame member 22 includes an inwardly facing mounting surface 28 that is spaced inwardly of the outer flange 46 of C-shaped portion 24. Mounting surface 28 is spaced inwardly so that when fixed pane 16 is mounted to mounting surface 28, pane 16 will be substantially aligned with movable windowpane 18. In this manner, fixed windowpane 16 and movable windowpane 18 may be substantially flush-mounted relative to one another, such that the outer surfaces of both windowpanes are generally coplanar. Also, although shown and described as having the movable windowpane positioned rearwardly of the fixed window with a forward edge of the movable windowpane being slidable with respect to frame member 22, it should be understood that the scope of the present invention includes other windowpanes where the movable pane may be oriented in other manners relative to one or more fixed panes or a second movable pane. For example, in a rear vehicle door, the movable pane could be forward relative to a fixed pane.

As noted above, windowpane 16 is preferably bonded to flange 26 and, further, preferably bonded to mounting surface 28. In addition, fixed windowpane 16 is preferably bonded to surface 28 inwardly of its outer perimeter edge 48 and, further, inwardly of a seal 50, which is mounted to the rearward edge of windowpane 16. Windowpane 16 is preferably bonded to frame member 22 using a bead of adhesive and preferably a bead of 2-part or 2-component urethane adhesive, such as described in commonly assigned patents, namely, U.S. Pat. Nos. 6,068,719; 6,319,344; 5,551,197; 6,298,606; 6,128,860; 5,966,874; 5,704,173; and 5,853,895, which are incorporated by reference herein in their entireties.

Referring again to FIG. 5, seal 50 comprises a three-sided seal formed from a first flange 52 that includes a first lip 54 that extends inwardly over an inner perimeter portion of fixed windowpane 16 and a second lip 56 that extends outwardly to close the gap between the outer perimeter portion of fixed windowpane 16. Seal 50 further includes a base portion 58 (from which lips 52 and 56 project) that is positioned adjacent the outer perimeter edge 48 of the fixed windowpane. Extending from an opposed side of base portion 58 is a second flange 57, which projects inwardly over an exterior perimeter portion of pane 16. Seal 50 is preferably extruded onto fixed windowpane and is formed from ethylene propylene deine monomer (EPDM), santoprene, TPE, or the like, and preferably has a durometer in a range of about 65-85 Durometer Shore A. In addition, the fixed windowpane 16 is preferably primed before the seal is applied onto the glass to enhance the adhesion of the seal to the windowpane. For example, the seal may be extruded on the glass or hand applied or machine applied. Pane 16 is preferably adhered to seal 32 using the “squeeze out” of bead of adhesive 51-that is the excess adhesive that flows or is displaced from bead 51 when pane 16 is pressed against flange portion 26. Alternately, seal 50, may be adhered to pane 16 using another suitable adhesive. Optionally, seal 32 may be bonded to frame member 22 by an adhesive and is also preferably formed from EPDM, santoprene, TPE or similar materials, to reduce the friction from the sliding action of movable pane 18.

After seal 50 is applied onto windowpane 16, the bead of adhesion is then applied adjacent lip 57 inwardly from the outer perimeter edge 48. After the bead of adhesion is applied, fixed windowpane 16 is then positioned and aligned with mounting surface 28 of frame member 22. The adhesive sets in a relatively short time, for example in approximately 2 to 10 seconds.

Referring to FIG. 6, and as noted previously, pane 16 is also mounted to bracket 42 and, further, preferably bonded to bracket 42 by a bead of adhesive that is applied to the lower edge portion of windowpane 16. Furthermore, bracket 42 is preferably secured or connected to or integral with frame member 22. For example, bracket 42 may be made integral with frame member 22 using conventional techniques, such as welding or the like. Alternately the beads of adhesive may be initially applied to the frame member and the bracket with the glass then positioned and aligned over the adhesive on the frame member and bracket.

As would be understood from the foregoing, window module 20, therefore, forms a rigid unitary structure that facilitates assembly of window assembly 10 and, further, facilitates remote assembly of window assembly 10.

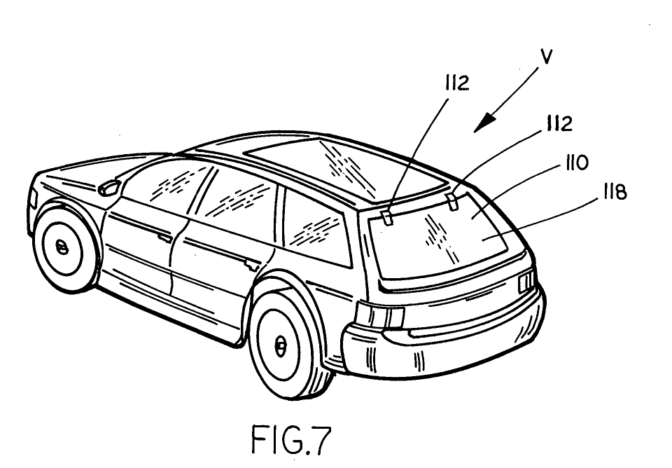

Referring to FIG. 7, the numeral 110 generally designates another embodiment of a window assembly of the present invention. Window assembly 110 comprises a hinged window assembly and which, in the illustrated embodiment, is illustrated mounted as a tailgate window of a vehicle V, which pivots about a horizontal axis at an upper edge of the windowpane. However, as will be more fully appreciated from the foregoing description, the principals employed in window assembly 10 may be employed in other window assemblies, including window assemblies that pivot around a vertical axis adjacent one of the windowpane's side edges, for example. Further, the principals employed in window assembly 10 may be incorporated in window assemblies that are mounted to the roof or in the side of the vehicle. As will be more fully described below, window assembly 110 is mounted by a pair of hinges 112 that exhibit increased longevity both functionally and aesthetically by providing an exterior surface that performs better in the environment of a vehicle exterior. For example, the hinges of the present invention do not exhibit the pitting and cracking that can be associated with conventional hinges, which are formed from zinc die cast members.

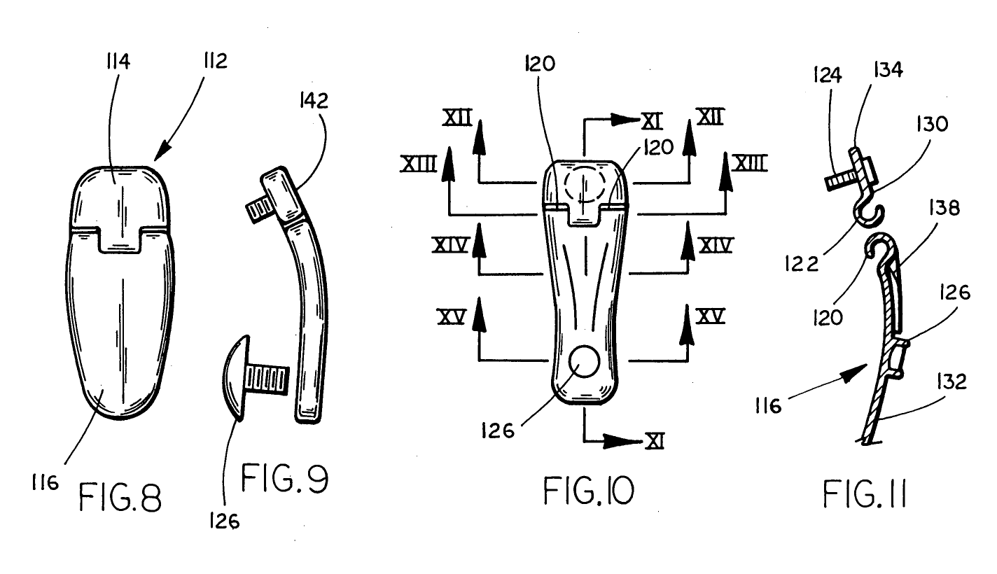

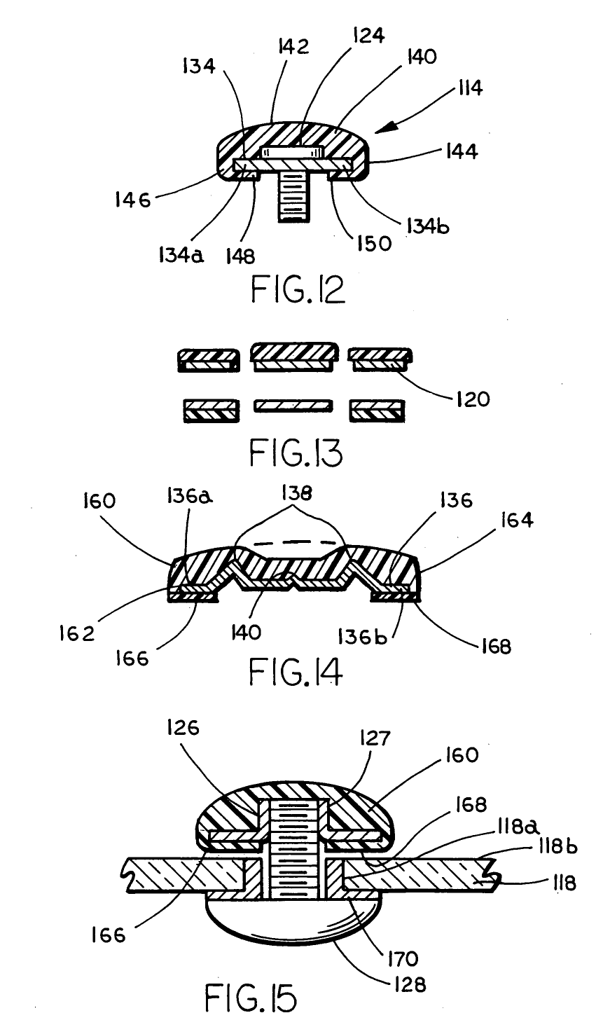

Referring to FIGS. 8-15, window assembly 110 comprises a hinged window assembly that is hinged to the body of a vehicle by hinges 112. Each hinge 112 includes a base 114, which is adapted for securing to the body of a vehicle, and a mounting portion 116, which is adapted for securing to the windowpane 118, such as a glass panel, and, further, which engages base 114 to thereby pivotally mount pane 118 about the vehicle body.

As best understood from FIGS. 9-11, mounting portion 116 includes a pair of hooked portions 120 that align with a corresponding hooked portion 122 provided on base member 114. When aligned, hooked portions 120 and hooked portion 122 from a pivot joint and receive a pin to thereby pivotally mount mounting member 116 to base member 114 and, hence, pivotally mount panel 120 to the vehicle body.

In the illustrated embodiment, base member 114 is mounted to a vehicle body by a fastener, such as a bolt 124 that extends through base member 114, for example at its central portion, to thereby secure base member 114 to the vehicle body. As best seen in FIG. 15, similarly, mounting member 116 includes a threaded bore 126, which may be formed by a raised annular lip 127, for receiving a second fastener 128 that extends through pane 118 from the inwardly facing side of the pane and into bore 126 to thereby secure mounting member 116 to the pane.

Referring to FIGS. 11-15, base member 114 and mounting member 116 are each formed from a stamped metal substrate 130, 132, respectively, which provide or form the structural portion or frame of the hinge. In the illustrated embodiment, substrates 130 and 132 preferably each comprise a stamped steel substrate, such as 1010 cold rolled steel (CRS), such as HSLA, with substrate 130 comprising a generally flat plate member 134 from which hook portion 122 depends. Similarly, substrate 132 comprises a plate member 136, which is reinforced by a plurality of ribs 138 and 140. Furthermore, as best seen in FIG. 11, ribs 138 extend to hook portions 120 to reinforce hook portions 120 and, further, extend adjacent bore 126 to similarly reinforce the point of attachment of mounting member 116 to pane 118.

As best understood from FIGS. 12-15, each substrate 130, 132 is at least partially encapsulated by a material that forms an outer surface of members 114 and 116 and which provides a decorative appearance for members 114 and 116. In the illustrated embodiment, base member 114 includes a body 140, which is formed from the material, preferably a thermoplastic material, such as PVC, polyethylene terapthalate (PET), a polypropylene, a nylon, an acrylonitrile-butadeine-styrene (ABS), or a thermoplastic urethane (TPU). Body 140 forms a generally curved outer surface 142 and, further, includes downwardly depending portions 144 and 146 which extend and encapsulate the opposed edges 134a, 134b of plate member 134. Furthermore, body 140 includes inwardly extending portions 148 and 150, which extend under plate 134, which provide the contact or mounting surface for base member 114. Therefore, in the preferred embodiment the outwardly facing or exposed surface of base member 114 is covered by body 140.

Mounting portion 116 is similarly encapsulated by a body 160 formed from the encapsulated material. Body 160 similarly includes downwardly depending portions 164 that extend around the opposed outer edges 136a, 136b of plate member 136 and, further, that wrap under plate member 136 to thereby at least partially encapsulate plate member 136. Inwardly depending portions 166 and 168 similarly provide the contact or mounting surface for member 116. Body 160 is also preferably formed from a thermoplastic material, such as noted above. Although illustrated as having a portion that generally follows the contour of plate member 136, it can be appreciated that body 160 may have an arcuate outer surface that extends the full length of mounting member 116 and, further, that follows the arcuate outer surface 142 of base 114 so that when mounting member 116 is mounted to base member 114, the outer surfaces of the respective members (114, 116) generally align to provide an aesthetically appealing hinge. Again, in preferred form the outer facing or exposed surface is covered by body 160.

Referring to FIG. 15, bolt 128 extends through a collar 170 positioned in the opening 1 18a of pane 118, which isolates and prevents contact between the bolt 128 and the glass pane 118. When bolt 128 is tightened to draws mounting member 116 against pane 118, inwardly extending portions 166 and 168 of body 160 seal against the outer surface 1 18b of panel 118 to thereby reduce the exposure of metal plate 136 to moisture or road debris. Similarly, when base member 114 is mounted to the vehicle, portions 148 and 150 will seal against the vehicle body.

As would be understood from the foregoing description, base member 114 and mounting member 116 are formed by placing the respective substrate, namely plate members 134, 136, in a mold apparatus in which bodies 140 and 160 are formed by injection molding the thermoplastic into the mold cavity to form the exterior surface of hinge 112. Furthermore, members 134 and 136 are preferably E-coated to improve the adhesion between the plastic body and the metal substrate. Such E-coating may include electro deposition, cathodic or anodic deposition.

As would be appreciated, therefore, the present invention provides a hinge that has an aesthetically pleasing exterior surface and, further, that is assembled from components that have sufficient rigidity to form a hinge that can sustain the weight of a glass panel, such as a tailgate glass panel and, further, that allows the hinge to match the color or complement the color of the vehicle by forming an outer surface whose color or texture may be easily modified. For example, the exterior surface of the hinge may be formed with a smooth finish or with a stipling, or mosaic, or pattern, including a logo or a design. In this manner, the present invention eliminates the need for the die casting processes typically associated with conventional hinges. In addition, since the exposed surface and contact surfaces are plastic, the hinge will not suffer from the deterioration that current hinges often undergo as a result of their exposure to the elements.

While several forms of the invention have been shown and described, further changes and modifications to the embodiments may be carried out without departing from the scope of the invention, which is defined by the claims that follow.

1. A vehicular window assembly comprising:
a frame member adapted for mounting in a vehicle, said frame member having an elongate channel formed therein for receiving a moving windowpane therein and having a mounting surface;
a fixed windowpane, said fixed windowpane having a perimeter edge, an inner surface, and an outer surface, said perimeter edge spaced from said frame member to thereby define a space;
a seal member mounted to at least said perimeter edge, said seal member substantially closing said space between said frame member and said fixed windowpane, and said inner surface of said fixed windowpane being secured to said mounting surface by a bead of adhesive wherein said frame member and said fixed windowpane comprise a window assembly module.

2. The vehicular window assembly according to claim 1, wherein said bead of adhesive is adjacent said seal member.

3. The vehicular window assembly according to claim 2, wherein said bead of adhesive adheres said seal to said fixed windowpane.

4. The vehicular window assembly according to claim 1, wherein said mounting surface comprises a mounting flange.

5. The vehicular window assembly according to claim 1, further comprising a movable window pane, said movable windowpane including first and second perimeter edges, wherein said first perimeter edge of said movable windowpane is slidably positioned in said elongate channel of said frame member.

6. The vehicular window assembly according to claim 5, wherein said frame member includes spaced opposed flanges, said opposed flanges defining said channel, said mounting surface being offset from said opposed flanges wherein said fixed windowpane is aligned with said movable pane such that the outer facing surfaces of the windowpanes are coplanar.

7. The vehicular window assembly according to claim 1 further including at least one seal provided in said elongate channel.

8. The vehicular window assembly according to claim 1, further comprising a bracket, said bracket providing a mounting surface for an exterior mirror assembly.

9. The vehicular window assembly according to claim 8, wherein said bracket is mounted to said frame member.

10. The vehicular window assembly according to claim 8, wherein said fixed windowpane is mounted to said bracket.

11. The vehicular window assembly according to claim 8, wherein said fixed windowpane is mounted to said bracket by a bead of adhesive.

12. The vehicular window assembly according to claim 1, wherein said window assembly comprises a window module for a vertical sliding window assembly.

13. A vehicular window assembly comprising:
a windowpane; and
a hinge comprising a base member and a mounting member, said base member adapted for mounting to a vehicle body, said mounting member mounted to said windowpane and pivotally mounted to said base member, at least one of said base member and said mounting member having a frame and a polymeric body at least partially encapsulating said frame.

14. The window assembly according to claim 13, wherein said polymeric body includes depending portions, said depending portions extending over said outer edges of said frame and extending inwardly under said outer edges to define contact surfaces for said frame.

15. The window assembly according to claim 13, wherein one of said mounting portion and said base member includes a pair of hooked portions and the other of said mounting portion and said base member including a hooked portion, said pair of hooked portions pivotally coupled to said hooked portion by a pin to thereby mount said mounting portion to said base member.

16. The window assembly according to claim 15, wherein said mounting portion includes said pair of hooked portions and said base member includes said hooked portion.

17. The vehicular window assembly according to claim 16, wherein each of said base member and said mounting member includes a frame and a polymeric body at least partially encapsulating its associated frame.

18. The window assembly according to claim 17, wherein said frames comprise stamped metal substrates.

19. The window assembly according to claim 18, wherein said frame of said mounting member includes a plurality of ribs to reinforce said frame.

20. The window assembly according to claim 19, wherein said ribs extending to said pair of hooked portions.
